(19) United States
(12) Patent Application Publication
(10) Pub. No.: US 2018/0336287 A1
(43) Pub. Date: Nov. 22, 2018

(54) A SYSTEM AND METHOD FOR RETRIEVING USER SPECIFIC RESULTS UPON EXECUTION OF A QUERY

(71) Applicant: HCL Technologies Limited, Noida (IN)

(72) Inventors: Shailendra Kumar ROHILLA, Noida (IN); Navin SAINI, Noida (IN)

(21) Appl. No.: 15/985,647

(22) Filed: May 21, 2018

(30) Foreign Application Priority Data
May 22, 2017 (IN) 201711017890

(51) Int. Cl. G06F 17/30

(52) U.S. Cl. CPC G06F 17/30997; G06F 17/30616; G06F 17/30979; G06F 17/30663

(57) ABSTRACT

Disclosed is a system for retrieving user specific results upon execution of a query. A search request receiving module receives a first search request comprising a search string and metadata of a client machine associated to a user. In one aspect, the metadata may be received upon executing a service component on the client machine in order to collect metadata associated to the client machine. The metadata is collected based on a set of parameters. A keyword determining module determines a first set of keywords from the metadata upon analyzing each parameter of the set of parameters. A search request forwarding module forwards a second search request comprising a second set of keywords to a search server. A search result module receives search results upon execution of the second search request by the search server and thereby displays the search results on a display unit belongs to the client machine.

### CROSS REFERENCE TO RELATED APPLICATIONS

The present application claims priority from Indian Patent Application No. 201711017890 filed on 22 May 2017 the entirety of which is hereby incorporated by reference.

### TECHNICAL FIELD

The present subject matter described herein, in general, relates to retrieve user specific results upon execution of a query.

### BACKGROUND

One of the biggest problems today in knowledge is the relevance of knowledge that people get from search engines. There are numerous search engines available that provide thousands of results to a query. For a user, it becomes very hard to analyze the thousands of results based on his/her requirements and interests. The problem becomes more acute specifically when the user belongs to a specific domain or industry. Since each user belongs to a different domain, it becomes cumbersome for the user to understand the thousands of results, returned from the query, for each domain.

### SUMMARY

Before the present systems and methods, are described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and methods for retrieving user specific results upon execution of a query and the concepts are further described below in the detailed description. This summary is not intended to identify essential features of the claimed subject matter nor is it intended for use in limiting the scope of the claimed subject matter.

In one implementation, a system for retrieving user specific results upon execution of a query is disclosed. The system may comprise a processor and a memory coupled to the processor. The processor may execute a plurality of modules present in the memory. The plurality of modules may comprise a search request receiving module, a keyword determining module, a search request forwarding module, and a search result module. The search request receiving module may receive a first search request comprising a search string and metadata of a client machine associated to a user. In one aspect, the metadata may be received upon executing a service component on the client machine in order to collect metadata associated to the client machine. The metadata may be collected based on a set of parameters. The keyword determining module may determine a first set of keywords from the metadata upon analyzing each parameter of the set of parameters. The search request forwarding module may forward a second search request comprising a second set of keywords to a search server. In one aspect, the second search request may comprise concatenation of the search string and the first set of keywords. The search result module may receive search results upon execution of the second search request by the search server. The search result module may further display the search results on a display unit belongs to the client machine.

In another implementation, a method for retrieving user specific results upon execution of a query is disclosed. In order to retrieve the user specific results, initially, a first search request comprising a search string and metadata of a client machine associated to a user may be received. In one aspect, the metadata may be received upon executing a service component on the client machine in order to collect metadata associated to the client machine. The metadata may be collected based on a set of parameters. Upon receipt of the first search request, a first set of keywords may be determined from the metadata upon analyzing each parameter of the set of parameters. Subsequent to the determination of the first set of keywords, a second search request comprising a second set of keywords to a search server may be forwarded. In one aspect, the second search request may comprise concatenation of the search string and the first set of keywords. After forwarding the second search request, search results may be received upon execution of the second search request by the search server. Post receipt of the search results, the search results may be displayed on a display unit belongs to the client machine thereby retrieving user specific results upon execution of the query. In one aspect, the aforementioned method for retrieving the user specific results upon execution of a query may be performed by a processor using programmed instructions stored in a memory.

In yet another implementation, non-transitory computer readable medium embodying a program executable in a computing device for retrieving user specific results upon execution of a query is disclosed. The program may comprise a program code for receiving a first search request comprising a search string and metadata of a client machine associated to a user, wherein the metadata is received upon executing a service component on the client machine in order to collect metadata associated to the client machine, and wherein the metadata is collected based on a set of parameters. The program may further comprise a program code for determining a first set of keywords from the metadata upon analyzing each parameter of the set of parameters. The program may further comprise a program code for forwarding a second search request comprising a second set of keywords to a search server, wherein the second search request comprises concatenation of the search string and the first set of keywords. The program may further comprise a program code for receiving search results upon execution of the second search request by the search server. The program may further comprise a program code for displaying the search results on a display unit belongs to the client machine thereby retrieving user specific results upon execution of a query.

### BRIEF DESCRIPTION OF THE DRAWINGS

The foregoing detailed description of embodiments is better understood when read in conjunction with the appended drawings. For the purpose of illustrating the disclosure, example constructions of the disclosure are shown in the present document; however, the disclosure is not limited to the specific methods and apparatus disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for retrieving user specific results upon execution of a query, in accordance with an embodiment of the present subject matter.

FIG. 2 illustrates the system, in accordance with an embodiment of the present subject matter.

FIG. 3 illustrates an example, in accordance with an embodiment of the present subject matter.

FIG. 4 illustrates a method for retrieving the user specific results upon execution of a query, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

The proposed invention facilitates to retrieve search results relevant to a user. In order to retrieve the search results, relevant to the user, a service component may be executed on a client machine associated to the user. The service component analyzes the client machine based on a set of parameters in order to retrieve data. Examples of the set of parameters may include, but not limited to, installed software applications on the client machine, frequency of usage of the installed software applications, output of the installed software applications, registry of the client machine, keywords used in each installed software application, domain of the client machine, running services on the client machine, and metadata pertaining to the installed software applications.

It may be understood that the service component continuously monitors activities being performed on the client machine and accordingly retrieves the data associated to the client machine. In one embodiment, the service component facilitates to retrieve the data from a registry of the client machine. The retrieval of the data from the registry may provide an indication of the domain associated to the user.

Upon continuously retrieving the data pertaining to the client machine, when a search string is received that sought for the search results relevant to the user, the search string is concatenated with one or more keywords, associated to the data and thereby the concatenation of the search string and the one or more keywords are forwarded to a search server for retrieving the search results. It may be understood that the one or more keywords facilitates to retrieve the search results relevant to the user. While aspects of described system and method for retrieving the user specific results upon execution of the query may be implemented in any number of different computing systems, environments, and/or configurations, the embodiments are described in the context of the following exemplary system.

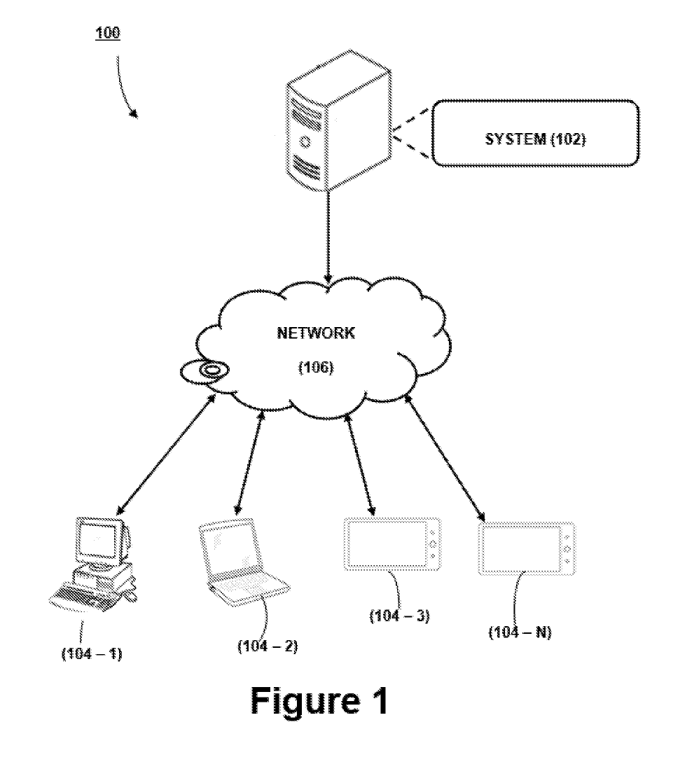

Referring now to FIG. 1, a network implementation 100 of a system 102 system for retrieving user specific results upon execution of a query is disclosed. The system 102, initially, receives a first search request comprising a search string and metadata of a client machine associated to a user. In one aspect, the metadata may be received upon executing a service component on the client machine in order to collect metadata associated to the client machine. The metadata may be collected based on a set of parameters. Upon receipt of the first search request, the system 102 determines a first set of keywords from the metadata upon analyzing each parameter of the set of parameters. Subsequent to the determination of the first set of keywords, the system 102 forwards a second search request comprising a second set of keywords to a search server. In one aspect, the second search request may comprise concatenation of the search string and the first set of keywords. After forwarding the second search request, the system 102 receives search results upon execution of the second search request by the search server. Post receipt of the search results, the system 102 displays the search results on a display unit belongs to the client machine thereby retrieving user specific results upon execution of the query.

Although the present disclosure is explained considering that the system 102 is implemented on a server, it may be understood that the system 102 may be implemented in a variety of computing systems, such as a laptop computer, a desktop computer, a notebook, a workstation, a mainframe computer, a server, a network server, a cloud-based computing environment. It will be understood that the system 102 may be accessed by multiple users through one or more user devices 104-1, 104-2 . . . 104-N, collectively referred to as user 104 or stakeholders, hereinafter, or applications residing on the user devices 104. In one implementation, the system 102 may comprise the cloud-based computing environment in which a user may operate individual computing systems configured to execute remotely located applications. Examples of the user devices 104 may include, but are not limited to, a IoT device, IoT gateway, portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

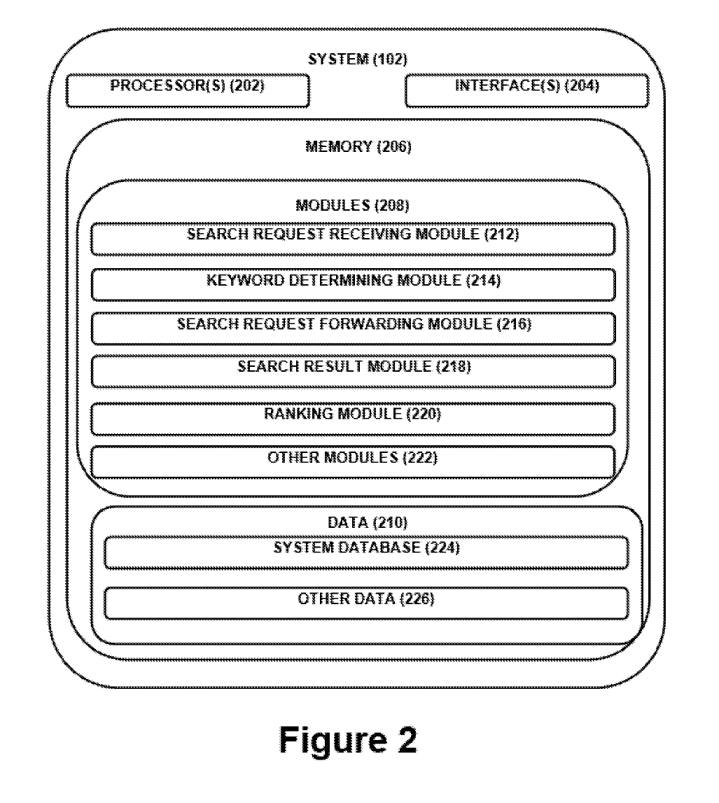

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a search request receiving module 212, a keyword determining module 214, a search request forwarding module 216, a search result module 218, a ranking module 220, and other modules 222. The other modules 222 may include programs or coded instructions that supplement applications and functions of the system 102. The modules 208 described herein may be implemented as software modules that may be executed in the cloud-based computing environment of the system 102.

The data 210, amongst other things, serves as a repository for storing data processed, received, and generated by one or more of the modules 208. The data 210 may also include a system database 224 and other data 226. The other data 226 may include data generated as a result of the execution of one or more modules in the other modules 222.

As there are various challenges observed in the existing art, the challenges necessitate the need to build the system 102 for retrieving user specific results upon execution of a query. In order to retrieve the user specific results, at first, a user may use the user device 104 to access the system 102 via the I/O interface 204. The user may register them using the I/O interface 204 to use the system 102. In one aspect, the user may access the I/O interface 204 of the system 102. To retrieve the user specific results, the system 102 may employ the search request receiving module 212, the keyword determining module 214, the search request forwarding module 216, the search result module 218, and the ranking module 220. The detail functioning of the modules is described below with the help of figures.

The search request receiving module 212 receives a first search request comprising a search string and metadata of a client machine associated to a user. The metadata may be received upon executing a service component on the client machine in order to collect metadata associated to the client machine. In one aspect, the metadata may be collected based on a set of parameters. Examples of the set of parameters may include, but not limited to, installed software applications on the client machine, frequency of usage of the installed software applications, output of the installed software applications, registry of the client machine, keywords used in each installed software application, domain of the client machine, running services on the client machine, and metadata pertaining to the installed software applications.

In one embodiment, the service component comprises programmable instructions stored in a file. The programmable instructions are programmed in a manner such that the programmable instructions collect the metadata associated to the client machine. The file, comprising the programmable instructions, may then executed by the system 102 on the client machine in order to collect the metadata based on the set of parameters as aforementioned. Examples of the metadata collected from the client machine by the service component is described as below.

The system 102 collects the metadata pertaining to the installed software applications on the client machine by using registry keys. Examples of the installed software applications may include, but not limited to, Visual Studio™, Java™, and SQL™.

The system 102 further collects the metadata regarding the frequency of usage of the installed software applications based on the registry key entries along with last usage of the installed software applications.

The system 102 further collects the output/logs of the installed software applications. In one aspect, based on the output/logs generated by various tools/software applications installed on the client device, the system 102 is able to analyze the work domain/technology etc. associated to the user.

The system 102 further collects the metadata based on the keywords used in each installed software application. In one aspect, the system 102 creates a customized service that may run continuously to get the metadata from any of the installed software application onto which that user is working on.

The system 102 further collects the metadata based on the domain of the client machine. Depending upon the domain used by the system 102 or an IP address, the system 102 may identify the domain in which the user is working. For example, this we may get from Windows™ security DLL file.

The system 102 further collects the metadata based on services running on the client machine.

The system 102 further collects the metadata based on a customized service that may analyze what is the current work going on the system. For example, coding of a module in a domain specific language or tool used in a specific domain.

In one embodiment, the service component continuously gets the metadata from the client machine along with the search string to be search by the user. It may be understood that while getting the metadata from the client machine, the system 102 may look to the additional information provided by the client machine in order provide more specific and relevant results for the user. Upon collecting the metadata from the client machine, the service component transmits the metadata to the search request receiving module 212. Subsequent to the receipt of the metadata, the keyword determining module 214 determines a first set of keywords from the metadata. The first set of keywords may be determined upon analyzing each parameter of the set of parameters.

After determination of the first set of keywords, the search request forwarding module 216 forwards a second search request, comprising a second set of keywords, to a search server. In one aspect, the second search request may comprise concatenation of the search string and the first set of keywords. The search server, upon receipt of the second search request, executes the second search request in order to retrieve search results.

Subsequently, the search result module 218 receives the search results upon from the search server. In one embodiment, after receiving the search results, the ranking module 220 ranks the search results based on a count of the second set of keywords matched with one or more keywords present in the search results. Post ranking the search results, the search result module 218 displays the search results on a display unit belongs to the client machine. Thus, in this manner, the system retrieves the user specific results upon execution of the query.

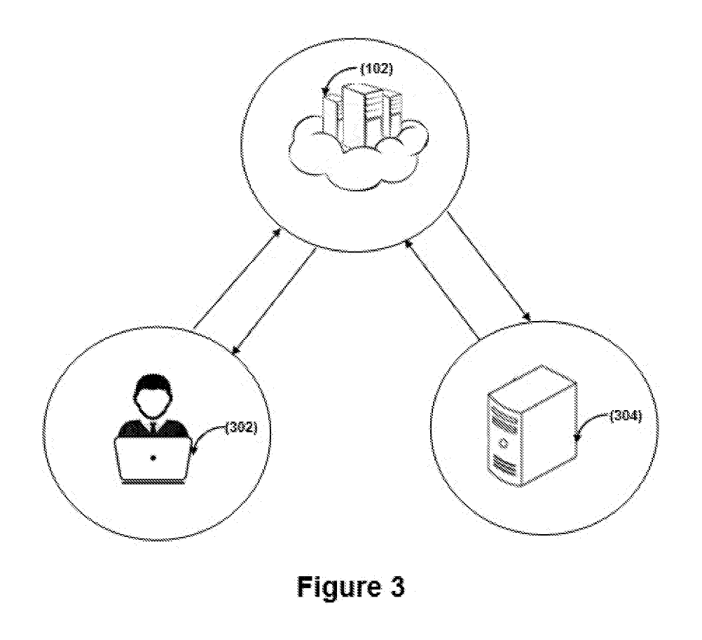

In order elucidate the aforementioned functionality of the system 102, consider an example where a user provides a query on the search server 304, as illustrated in the FIG. 3. In order to retrieve the user specific results, the search request receiving module 212 receives a first search request comprising a search string as “PAM” and metadata of a client machine 302 associated to a user. It may be understood that the user is a Software Engineer and installed various Software development applications (such as Visual Studio™ Java™, and SQL™) on the client machine 302. It is to be noted that the metadata is collected based on a set of parameters associated Visual Studio™, Java™, and SQL™ applications.

Subsequently, the keyword determining module 214 determines a first set of keywords from the metadata upon analyzing each parameter of the set of parameters. The search request forwarding module 216 then forwards a second search request comprising a second set of keywords to a search server 304. In one aspect, the second search request may comprise concatenation of “PAM” and keywords associated to Visual Studio™, Java™, and SQL™. The search result module 218 then receives search results upon execution of the second search request by the search server 304. Since the user is a Software Engineer, the search result module 218 receives the search results from the search server 304 as,

“https://en.wikipedia.org/wiki/Linux_PAM”, or
“http://www-01.ibm.com/support/docview.wss?uid=swg21498057”

On the other hand, when the user is an Electronic Engineer or a Medical Professional, the search result module 218 receives the search results from the search server 304 as,

“https://en.wikipedia.org/wiki/Pulse-amplitude_modulation”, or
“https://en.wikipedia.org/wiki/Pralidoxime” respectively.

The search result module 218 then displays the search results on a display unit belongs to the client machine 302. Thus, in this manner, it is to be noted that the system retrieves the user specific results based on the set of parameters associated to the client machine 302.

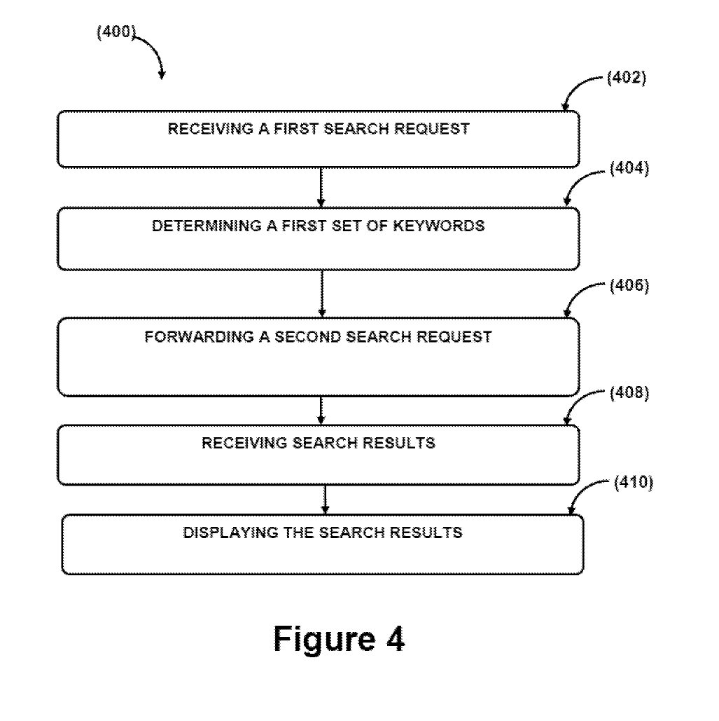

Referring now to FIG. 4, a method 400 for retrieving user specific results upon execution of a query is shown, in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented as described in the system 102.

At block 402, a first search request comprising a search string and metadata of a client machine 302 associated to a user may be received. In one aspect, the metadata may be received upon executing a service component on the client machine 302 in order to collect metadata associated to the client machine 302. The metadata may be collected based on a set of parameters. In one implementation, the first search request may be received by the search request receiving module 212.

At block 404, a first set of keywords may be determined from the metadata upon analyzing each parameter of the set of parameters. In one implementation, the first set of keywords may be determined by the keyword determining module 214.

At block 1006, a second search request, comprising a second set of keywords, may be forwarded to a search server 304. In one aspect, the second search request comprises concatenation of the search string and the first set of keywords. In one implementation, the second search request may be forwarded by the search request forwarding module 216.

At block 408, search results may be received upon execution of the second search request by the search server 304. In one implementation, the search results may be received by the search result module 218.

At block 410, the search results may be displayed on a display unit belongs to the client machine 302 thereby retrieving the user specific results upon execution of the query. the search results may be displayed by the search result module 218.

Exemplary embodiments discussed above may provide certain advantages. Though not required to practice aspects of the disclosure, these advantages may include those provided by the following features.

Some embodiments enable a system and a method to provide more relevant results to the users.

Some embodiments enable a system and a method to save time in order to filter the results.

Although implementations for methods and systems for retrieving user specific results upon execution of a query have been described in language specific to structural features and/or methods, it is to be understood that the appended claims are not necessarily limited to the specific features or methods described. Rather, the specific features and methods are disclosed as examples of implementations for retrieving the user specific results.

1. A method for retrieving user specific results upon execution of a query, the method comprising:
receiving, by a processor, a first search request comprising a search string and metadata of a client machine associated to a user, wherein the metadata is received upon executing a service component on the client machine in order to collect metadata associated to the client machine, and wherein the metadata is collected based on a set of parameters;
determining, by the processor, a first set of keywords from the metadata upon analyzing each parameter of the set of parameters;
forwarding, the processor, a second search request, comprising a second set of keywords, to a search server, wherein the second search request comprises concatenation of the search string and the first set of keywords;
receiving, by the processor, search results upon execution of the second search request by the search server; and
displaying, by the processor, the search results on a display unit belongs to the client machine thereby retrieving user specific results upon execution of a query.

2. The method of claim 1, wherein the set of parameters comprises installed software applications on the client machine, frequency of usage of the installed software applications, output of the installed software applications, registry of the client machine, keywords used in each installed software application, domain of the client machine, running services on the client machine, and metadata pertaining to the installed software applications.

3. The method of claim 1 further comprises ranking the search results based on a count of the second set of keywords matched with one or more keywords present in the search results.

4. A system for retrieving user specific results upon execution of a query, the system comprising:
a processor; and
a memory coupled to the processor, wherein the processor is capable of executing a plurality of modules stored in the memory, and wherein the plurality of modules comprising:
a search request receiving module for receiving a first search request comprising a search string and metadata of a client machine associated to a user, wherein the metadata is received upon executing a service component on the client machine in order to collect metadata associated to the client machine, and wherein the metadata is collected based on a set of parameters;
a keyword determining module for determining a first set of keywords from the metadata upon analyzing each parameter of the set of parameters;
a search request forwarding module for forwarding a second search request, comprising a second set of keywords, to a search server, wherein the second search request comprises concatenation of the search string and the first set of keywords; and
a search result module for
receiving search results upon execution of the second search request by the search server; and
displaying the search results on a display unit belongs to the client machine,
thereby retrieving user specific results upon execution of a query.

5. The system of claim 4, wherein the set of parameters comprises installed software applications on the client machine, frequency of usage of the installed software applications, output of the installed software applications, registry of the client machine, keywords used in each installed software application, domain of the client machine, running services on the client machine, and metadata pertaining to the installed software applications.

6. The system of claim 4 further comprises a ranking module for ranking the search results based on a count of the second set of keywords matched with one or more keywords present in the search results.

7. A non-transitory computer readable medium embodying a program executable in a computing device for retrieving user specific results upon execution of a query, the program comprising a program code:
a program code for receiving a first search request comprising a search string and metadata of a client machine associated to a user, wherein the metadata is received upon executing a service component on the client machine in order to collect metadata associated to the client machine, and wherein the metadata is collected based on a set of parameters;
a program code for determining a first set of keywords from the metadata upon analyzing each parameter of the set of parameters;
a program code for forwarding a second search request, comprising a second set of keywords, to a search server, wherein the second search request comprises concatenation of the search string and the first set of keywords;
a program code for receiving search results upon execution of the second search request by the search server; and
a program code for displaying the search results on a display unit belongs to the client machine thereby retrieving user specific results upon execution of a query.
